(19) United States
(12) Patent Application Publication
(10) Pub. No.: US 2005/0120604 A1
(43) Pub. Date: Jun. 9, 2005

(54) Illuminated identification panel

(76) Inventor: Darrel Robert Slowski, Schomberg (CA)

Correspondence Address: D.W. EGGINS, 18 DOWNSVIEW DRIVE, BARRIE, ON, L4M 4P8, CA

(21) Appl. No.: 10/729,927

(22) Filed: Dec. 9, 2003

(51) Int. Cl. H05B 37/00

(52) U.S. Cl. 40/542

(57) ABSTRACT

A long-range house number identification panel has its number indicia mounted on an illuminated viewing screen, being individually readable with the naked eye from up to 200 feet distance. An electrically energizable phosphorescent screen behind the indicia serves to illuminate the numbers at night. The identifying indicia may consist of transparencies through the surface of a blanking screen. A photocell switches off the screen in daylight; and the level of screen illumination may be limited below the optimum, by operating at a reduced voltage so as to extend the service life of the screen. A u/v barrier coat may be used to protect the phosphor of the screen against solar degradation.

### CROSS REFERENCE TO RELATED APPLICATIONS

Not Applicable

### STATEMENT REGARDING FEDRALLY SPONSORED RESEARCH OR DEVELOPMENT

Not Applicable

### REFERENCE TO MICROFICHE APPENDIX

Not Applicable

### BACKGROUND OF THE INVENTION

1. This invention is directed to a back-lighted phosphorescent panel for silhouetting identification indicia, such as house numbers, and in particular to a panel having long range visibility, for remote viewing.

2. There are products presently available in the market for use with house address numbers, wherein a planar panel is backlighted by phosphor-based luminescence, to silhouette dark numbers which block off selected areas of the lighted surface.

These prior art products are characterized by a number of disadvantageous aspects:
1) the panels are limited in size, usually to rectangles about 3-inches by 5-inches;
2) many of the panels are permanently energized, being connected to the door-bell power circuit, thereby reducing the working life of the panel;
3) the panels are subject to ultra-violet degradation, becoming bleached by sunlight. The small, three inch by five inch size of existing panels defeats a major safety potential of such signage, which is the rapid identification of a property address by distant-viewing from a remote vantage point in the adjacent street at times of crisis and extreme emergency. At the present time, when an emergency alarm is generated for a service such as the Fire Service, in answer to a domestic call involving a fire or a heart attack, it is frequently necessary for a pilot, spotter vehicle to precede the response team, in order to locate the given address of the premises where the crisis has originated. In such instances, the currently available above-mentioned illuminated signage is generally completely indecipherable from the street, owing to its undue size limitation, rendering it virtually useless at a time when it is most needed. The delay presently associated with this circumstance may prove in some instances to be fatally critical.

### BRIEF SUMMARY OF THE INVENTION

The present invention provides an illuminated signage consisting of weatherproof, wall-mountable display having a frame enclosing a planar, backlighted screen. In one embodiment the screen is some 4¾ inches by 9¼ inches, suitable for use with characters as large as four inches high, such as four such numbers, which are mounted upon the face of the screen, in obscuring relation with predetermined areas of the screen, so that the characters appear in silhouette, with a lighted background. Customized graphics may also be used with the panel.

The “lamp” (i.e. the lighted area of the screen) can be rectangular, ovoid or other selected shape, in accordance with the shape of the screen housing, which is usually a plastic moulding.

In the dark, signs in accordance with the invention are readable from some two hundred feet away.

A preferred embodiment of the present invention has a u/v protective coating applied to the face of the screen, to limit or preclude damage from the sun.

A further characteristic of the subject invention is the use of a photocell, to de-energise the screen when a predetermined level of local illumination, such as daylight occurs. This de-energizing is achieved by interrupting the low voltage D.C. circuit of the photoluminescent screen. The result of interrupting the energization of the screen is to terminate its light emission, and to correspondingly extend the life expectancy of the screen.

A further characteristic of the present invention is the operation of the screen at a reduced voltage such that the level of luminescence is reduced to an acceptable degree without unduly compromising visibility, while correspondingly extending the life expectancy of the phosphor.

As a consequence of the foregoing innovations, the subject invention provides a unitary photo-luminescent signage of sufficient area to illuminate a plurality of four-inch high symbols, possessing u/v protection of the screen face, and operating at a reduced voltage, less than the permissible optimum, and possessing anticipated extended life expectancy.

The screen has a light-toned colour, so that in daylight conditions when the screen is not energized, the dark-coloured indicia are clearly visible, in contrast against the light-toned screen.

The indicia may be protected against the elements and unauthorized tampering by a clear protective mask. This mask may incorporate the u/v protective layer.

As an alternative arrangement to the use of superimposed indicia, an opaque mask may be used, having the indicia or other visual display matter as clear surface areas of the mask, so that the revealed illuminated surface of the screen will be in the form of the desired indicia or display.

The term “opaque indicia means” is intended to encompass both the superimposed opaque individual indicia and the opaque mask having indicia as unobstructed screen areas.

The subject signage may be powered by household power, through a step-down transformer, by a solar cell, or alternative electrical sources.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a perspective front view of a domestic embodiment of the subject illuminated identification panel; and,

FIG. 2 is a schematic section view of the subject panel, illustrating certain of its characteristics.

### DETAILED DESCRIPTION OF THE INVENTION

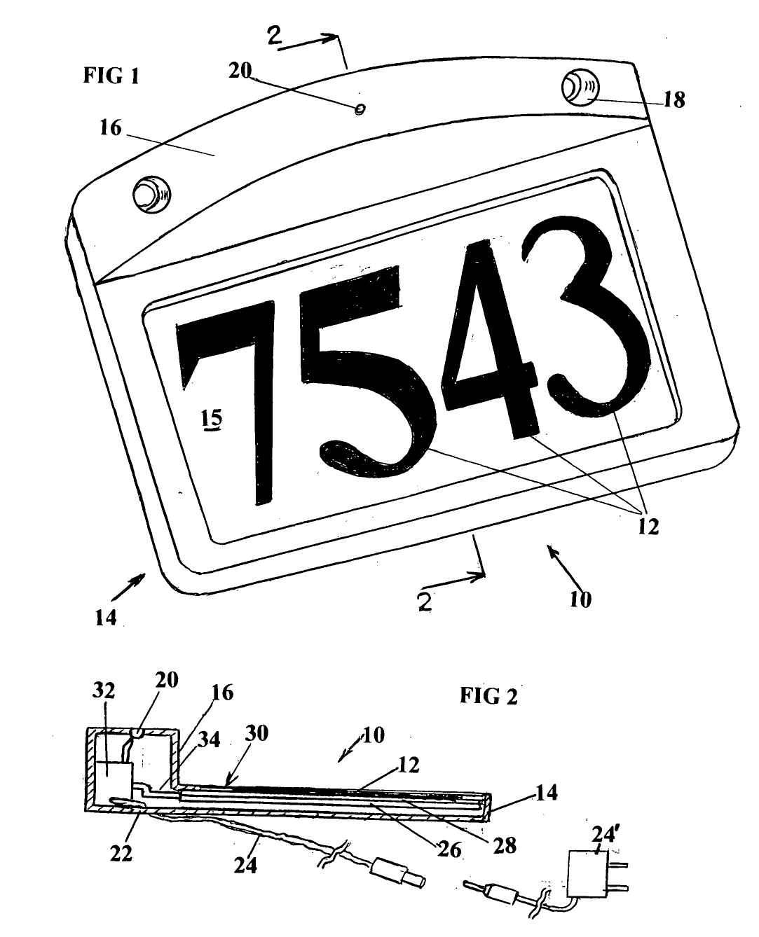

Referring to FIG. 1, a photo-luminescent panel 10 in accordance with the present invention is of a size to show a plurality of four-inch indicia 12, indicated herein as four Arabic numerals, 7, 5, 4, 3, 2 indicative of a Street address number.

The illuminated screen 15 has an exposed area of 4¾ inches by 9¼ inches, to provide good light profiling of up to four 4-inch, substantially opaque numbers, with adequate illuminated surround for easy distant viewing. In the case of a “negative” display (as in ‘photographic negative’), wherein the characters appear as lighted screen surface, with adjoining surface areas being blanked off, the characters can be yet larger, and extend to the screen edges.

A raised bridge portion 16 of the housing 14 has a pair of screw recesses 18 into which support screws (not shown) are inserted, for mounting the panel on a vertical support surface.

A photo cell 20 is mounted centrally within the bridge portion 16. Referring to FIG. 2, the panel 10 has a removable back cover 22 through which is connected a power cord 24.

Within the housing 14 is a copper backing 26 and phosphor coating 28 which serves as the light emitter 30, being connected to an external power source, as represented by the connecting cord 24. Power may be by way of a transformer/rectifier 24′ connected with a domestic house circuit, or by connection to a bell-circuit, or a solar cell, neither of which are shown.

The photo cell 20 is connected in controlling relation with the ‘on/off’ switching relay 32 to control the series connection between the external power supply as represented by the power connection 24 and the light emitter 30, so as to open-circuit the connection 34 during daylight hours, and to close, and energize emitter 30 when ambient light dims to a pre-set threshold level. Thus, when daylight diminishes and the photo cell 20 operates, this permits the emitter 30 to become energized, and the panel 10 becomes illuminated, thereby back-lighting the indicia 12, or lighting the perforations of a ‘negative’ screen.

One such ‘negative’ indicia screen may comprise a clear plastic having the desired indicia areas unobstructed, and the remainder of its surface blanked off. This particular arrangement then permits the use of the full screen dimensions, such that, in the instance of the embodiment herein described, indicia may extend to the edges of the screen, i.e. up to 4¾ inches high; giving an 18% increase in effective indicia dimension, compared to four inch indicia numbers. By use of a dark paint as the blanking medium, the “blonde” surface of the screen shows through in contrast, in daylight conditions when the screen is not energized.

It is contemplated that a specialty installation might comprise a “negative” screen in which the blanking medium (probably a paint) might be precisely the same colour as the colour of the non-illuminated screen. In this case, the screen would be an apparent blank under non-illuminated conditions, and the indicia would only be viewable when the screen is energized.

This type of identification panel might be used within a secured, enclosed establishment, wherein access to restricted areas is obstructed, by an absence of room or zone identification, which can be instantly overcome by operation of the energizing circuit for the identifying sign of the selected zone.

1. A luminescent display for use in illuminating identification indicia, including a housing for attachment to a support surface; a phosphorescent screen having a useful area in excess of twenty square inches, substantially opaque indicia means mounted on said screen; and electrical energizing means connected to the screen for applying a predetermined voltage to the screen in energizing relation therewith to illuminate the indicia means, whereby the indicia are identifiable for remote viewing when the screen is energized.

2. The luminescent screen as set forth in claim 1, including light-responsive cut-out means to disconnect said energizing means from said screen when ambient light exceeds a predetermined threshold level.

3. The luminescent screen as set forth in claim 1, including ultra violet masking means located in protective relation with said screen, to limit the adverse effects of u/v rays impinging on said screen.

4. The luminescent screen as set forth in claim 1, wherein said electrical energizing means has a predetermined output voltage less than the rated voltage of said screen, to energize said screen to a predetermined level of illumination, whereby the life expectancy of said screen is extended.

5. The luminescent screen as set forth in claim 1, wherein said phosphorescent screen has a light-toned colour, and said opaque indicia means are dark coloured, to provide a readily visible contrast under external illumination, for easy legibility.

6. The luminescent screen as set forth in claim 2, wherein said light-responsive cut-out means includes a photo cell incorporating a light-actuated switch that goes to an open circuit condition on exposure to ambient light of predetermined intensity.

7. A long-range house number identification panel, having a plurality of number indicia in selected arrangement upon a viewing screen, said indicia being individually readable with the naked eye from up to 200 feet distance, an electrically energizable phosphorescent screen located behind said indicia; electrical supply means connected with said screen to provide to said screen a predetermined voltage of limited value, and switch means in controlling relation with said supply means, to enable operation of said panel under predetermined ambient light conditions.

8. The identification panel as set forth in claim 7, wherein said number indicia have a height of up to about four inches.

9. The identification panel as set forth in claim 8 having a lateral width to accommodate four of said indicia.

10. The identification panel as set forth in claim 7, wherein said indicia are selected from the group consisting of separate, individual indicia of opaque material, and an opaque sheet having apertures therethrough shaped in the form of said indicia to permit the passage of light from said screen when energized.

11. A luminescent display for use in illuminating identification indicia, including a housing for attachment to a support surface; a phosphorescent screen having a useful viewable area, substantially opaque indicia means mounted on said screen; and electrical energizing means connected to the screen for applying a predetermined voltage to the screen in energizing relation therewith to illuminate the indicia means, whereby the indicia are identifiable for viewing when the screen is energized, wherein said predetermined voltage is limited to a value less than the rated value of said screen, to extend the service life expectation for the screen

12. The luminescent screen as set forth in claim 11, including light-responsive cut-out means to disconnect said energizing means from said screen when ambient light exceeds a predetermined threshold level.

13. The luminescent screen as set forth in claim 11, wherein said phosphorescent screen has a light-toned colour, and said opaque indicia means are dark coloured, to provide a readily visible contrast under external illumination, for easy legibility.

14. The luminescent screen as set forth in claim 11, said phosphorescent screen having a usefull area in excess of twenty square inches, said indicia being up to about four inches in height, whereby the indicia are identifiable for remote viewing when the screen is energized.
